(19) United States
(12) Patent Application Publication
(10) Pub. No.: US 2012/0202629 A1
(43) Pub. Date: Aug. 9, 2012

(54) ACTIVE CONTROL TENSIONER

(75) Inventor: Fenton O'Shea, Groton, NY (US)

(73) Assignee: BORGWARNER INC., Auburn Hills, MI (US)

(21) Appl. No.: 13/394,952

(22) PCT Filed: Sep. 8, 2010
(86) PCT No.: PCT/US10/48055

§ 371 Date: Mar. 8, 2012

Related U.S. Application Data
(60) Provisional application No. 61/242,410, filed on Sep. 15, 2009.

(51) Int. Cl. F16H 7/08

(52) U.S. Cl. 474/110

(57) ABSTRACT

A tensioner system for an engine including at least one driven sprocket, at least one driving sprocket, a chain, and a tensioner for tensioning the chain. The damping of the tensioner is actively controlled by a valve that allows fluid to exit the tensioner.

### REFERENCE TO RELATED APPLICATIONS

This application claims one or more inventions which were disclosed in Provisional Application No. 61/242,410 filed Sep. 15, 2009, entitled “ACTIVE CONTROL TENSIONER”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of tensioners. More particularly, the invention pertains to an actively controlled tensioner.

2. Description of Related Art

Prior art tensioners reactively tension chains based on the tension in the chain strand and are not actively controlled.

### SUMMARY OF THE INVENTION

A tensioner system for an engine including at least one driven sprocket, at least one driving sprocket, a chain, and a tensioner for tensioning the chain. The damping of the tensioner is actively controlled by a valve that allows fluid to exit the tensioner.

The valve may be locating within the tensioner housing or body or alternatively, located remotely from the tensioner.

The tensioner may be a linear tensioner or a rotary tensioner. The tensioner may have a rack.

### BRIEF DESCRIPTION OF THE DRAWING

FIG. 1 shows a schematic of an actively controlled rotary tensioner with a chain of a first embodiment.

FIG. 2 shows a schematic of an actively controlled rotary tensioner of a first embodiment moving towards a first position.

FIG. 3 shows a schematic of an actively controlled rotary tensioner of a first embodiment moving towards a second position.

FIG. 4 shows a schematic of an actively controlled rotary tensioner of a first embodiment moving towards a third position.

FIG. 5 shows a schematic of an actively controlled linear tensioner with a valve in the body of a second embodiment moving towards a first position.

FIG. 6 shows a schematic of an actively controlled linear tensioner with a valve in the body of a second embodiment moving towards a second position.

FIG. 7 shows a schematic of an actively controlled linear tensioner with a valve in the body of a second embodiment moving towards a third position.

FIG. 8 shows a schematic an actively controlled linear tensioner with a valve in the body of a third embodiment.

FIG. 9 shows a schematic of an actively controlled linear tensioner with a valve in the body of a fourth embodiment.

FIG. 10 shows a schematic of an actively controlled linear tensioner with a valve in the body of a fifth embodiment moving towards a first position.

FIG. 11 shows a schematic of an actively controlled linear tensioner with a valve in the body of a fifth embodiment moving towards a second position.

FIG. 12 shows a schematic of an actively controlled linear tensioner with a valve in the body of a fifth embodiment moving towards a third position.

### DETAILED DESCRIPTION OF THE INVENTION

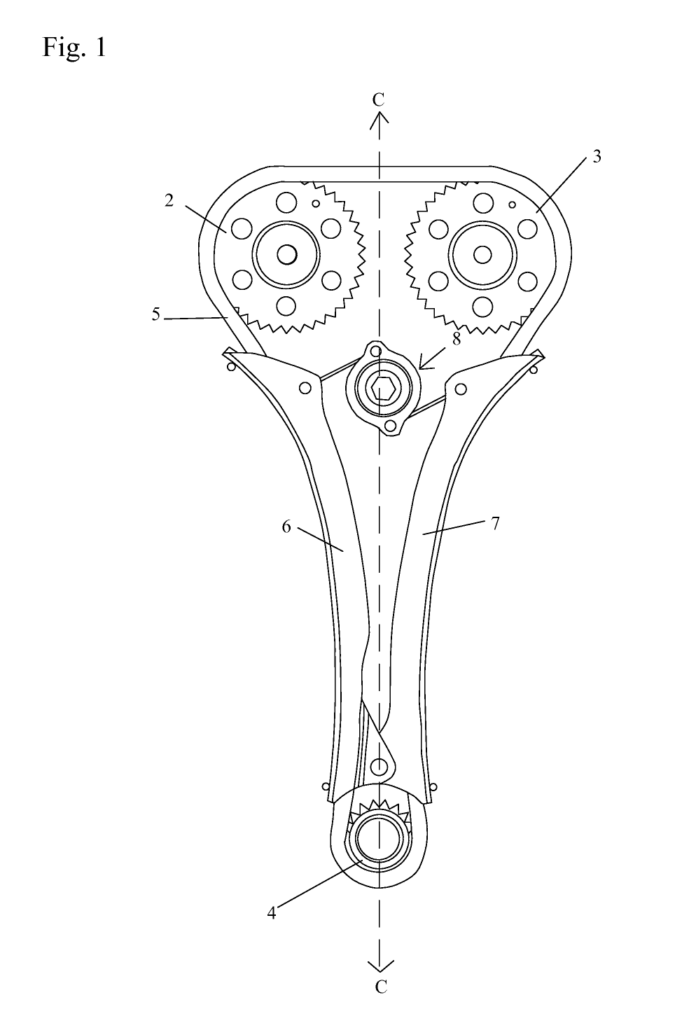

FIGS. 1-4 show an actively controlled tensioner 8 in a first embodiment. An actively controlled tensioner is an active control tensioner is a tensioner that changes the fluid restriction in order to modify the tensioner damping characteristics. The rotary tensioner 8 may be used in an engine timing system with a drive sprocket 4, at least one driven sprocket 2, 3, and a power transmission chain 5 or belt as shown in FIG. 1. The rotary tensioner 8 is coupled to a valve 28 for active control of the damping of the rotary tensioner. In the example shown, blade shoes 6, 7 are present on either strand of the power transmission chain 5.

The rotary tensioner 8 is generally centered with respect to a center line C extending between the driven sprockets between the two strands of the chain 5. The rotary tensioner 8 is connected to the blade shoes 6, 7.

Alternate configurations of the drive sprocket 4, driven sprockets 2, 3, blade shoes 6, 7, and transmission chain 5, and placement of the rotary tensioner 8 relative to the sprockets 2, 3, 4, blade shoes 6, 7, and chain 5, and how the rotary tensioner 8 may be attached to the blade shoes 6, 7 are not limited to the configuration or means shown in FIG. 1.

Secured within the tensioner housing 10 of the rotary tensioner is a rotary body 9 with vanes 11, 12, 13, 14 which are rotatable around a central pivot point. In one embodiment, the tensioner housing 10 defines at least one chamber 15 that receives a vane 11. The at least one chamber is in fluid communication with an oil pump 20 through hydraulic lines 22 and a valve 28 through hydraulic line 26. A torsion spring (not shown) may be present between the tensioner housing 10 and the rotary body 9 to bias the rotary body to a position in which fluid to hydraulic line 22 is restricted.

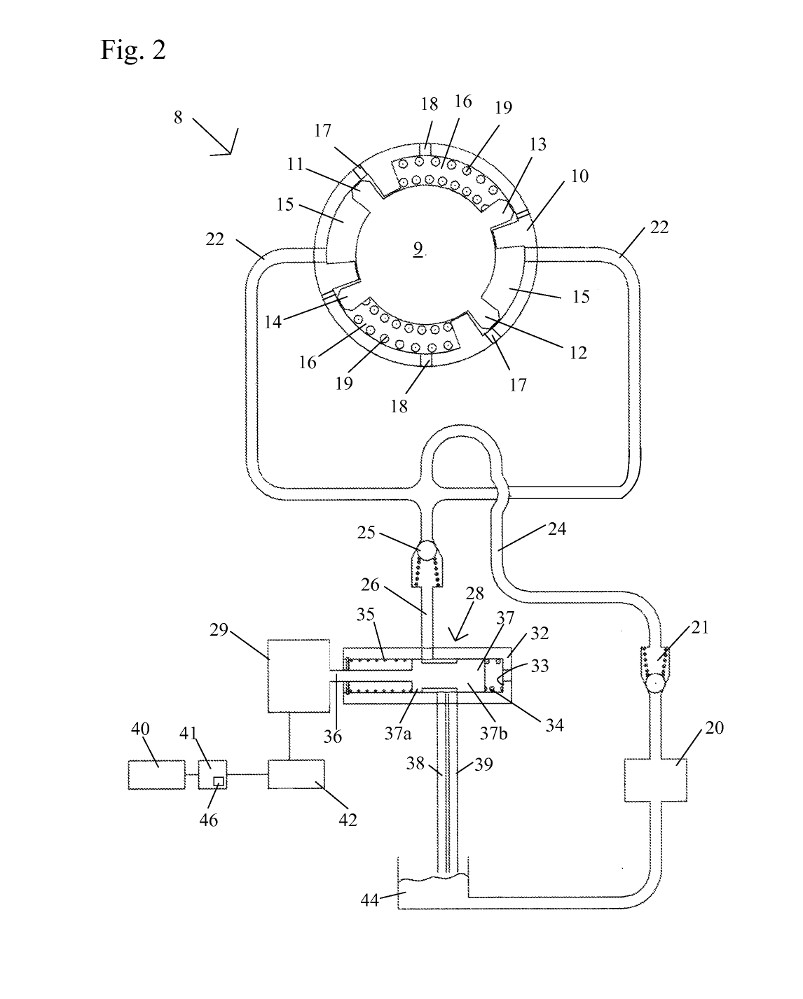

In an alternate embodiment, the tensioner housing 10 defines two types of chambers 15, 16. While a configuration of four total chambers is shown in the Figures, one skilled in the art would be able to use any number of chambers. The first set of chambers 15 receives vanes 11 and 12. The second set of chambers 16 receives vanes 13 and 14. The first set of chambers 15 with vanes 11 and 12, and are each in fluid communication with an oil pump 20 through hydraulic lines 22, 24 and a valve 28 through hydraulic lines 22, 26. A flow path 17 to atmosphere is present within the chambers 15 to allow any air, vapor, or oil leakage to escape, preventing the rotary tensioner from locking up. The flow paths 17 do not normally vent oil. In the second set of chambers 16, vanes 13, 14 are actuated by springs 19. Alternatively, a torsion spring (not shown) may be present between the tensioner housing 10 and the rotary body 9 to bias the rotary body instead of springs 19 in a second set of chambers 16 as shown in FIGS. 2-4. The chambers 16 are open to atmosphere through flow paths 18 to allow any air or oil that may enter the chambers 16 to exit.

Within hydraulic line 26 is preferably a pressure relief valve 25 that has a “pop off” pressure, a pressure at which the ball lifts off of the valve seat that is greater than the oil pump system pressure to disallow oil pump 20 leakage to directly flow to oil reservoir 44. A pressure relief valve 21 is also preferably present in the hydraulic line 24 between the oil pump 20 and the chambers 15 to prevent any backflow from occurring back into the oil pump 20.

The valve 28 in fluid communication with the rotary tensioner 8 includes a valve housing 32 with a bore 33 for slidably receiving a spool 37. The spool has at least two cylindrical lands 37a, 37b, which fit snugly within the valve housing 32 and are capable of selectively blocking the flow of engine oil to at least one line, although two lines 38, 39 are preferably used. The hydraulic line preferably has a flow restrictor. While two hydraulic lines are shown, only one hydraulic line or multiple hydraulic lines may be used as well as multiple flow restrictors per line. The valve 28 may be located remotely from the rotary tensioner 8 or may alternatively be present in the rotary body 9 of the rotary tensioner 8.

The position of spool 37 within valve housing is influenced by two distinct sets of opposing forces. Spring 34 acts on the end of land 37b and resiliently urges spool 37 to the left in the orientation illustrated in FIGS. 2-4. A second spring 35 acts on land 37a and resiliently urges spool 37 to the right in the orientation illustrated in FIGS. 2-4. Land 37a preferably has a diameter that is large enough to prevent backflow against the actuator 29. A spool extension 36 is present at the end of the spool land 37a and is in contact with actuator 29.

A force from an actuator 29, preferably a variable force solenoid, is exerted on an end of spool land 37a and is controlled by a pressure control signal from controller 42, preferably of the pulse-width modulated type (PWM), in response to a control signal from electronic engine control unit (ECU) 41. The ECU 41 receives an input signal with data from existing engine sensors 40. The input signal may be based on various engine control parameters and preferably include, but is not limited to oil temperature, oil pressure, coolant temperature, phaser angle, throttle position, drive mode/drive gear, ambient temperature, number of hours on the system, engine revolutions per minute (RPM), and/or other engine parameters. Within the ECU 41 there preferably is a tensioner map 46 that preferably includes a pre-calibrated matrix based on the function required for a specific engine model. Based on the tensioner map 46 and an input signal, the ECU 41 sends a signal to the controller 42 to regulate the position of the valve 28.

Referring to FIG. 2, as the force of the actuator 29 on the spool land 37a is increased, the spool 37 is urged to the far right towards a position, by force of the actuator 29 and spring 35 until the force of the actuator 29 and spring 35 on the spool land 37a is equal to or balanced with the force of the spring 34 on the opposite side of the spool 37. When the spool is in this first position, the second land 37b unblocks lines 38, 39 to oil reservoir 44, allowing oil to flow from chambers 15, assuming the pressure is great enough in the hydraulic line 26 to overcome the pop off pressure of the pressure relief valves 25, and flow through the valve 28 and out at least one of the lines 38, 39 to oil reservoir 44 or sump.

The amount of damping of the rotary tensioner 8 is dependent on the number of lines 38, 39 that are open to oil reservoir 44 or sump and the chambers 15, and may become increasingly softer as more than one line 38, 39 between the valve 28 and the oil reservoir 44 or sump is allowed to drain to oil reservoir 44 or sump. With the fluid exiting the chambers 15 the damping of the chain 5 by the rotary tensioner 8 becomes softer and at its extreme limit there is either full restriction of flow of or virtually no amount of resistance to the flow of fluid out of the chambers 15.

Inside the practical range of the tensioner, the more the tensioner leaks, the softer the tensioner is and more energy is lost to pumping and greater effective damping results. The less the tensioner leaks, the less soft the tensioner is and the less energy is lost to pumping and less effective damping results.

With the fluid exiting through lines 38, 39 to oil reservoir 44, the decrease in oil pressure in the chambers 15 due to the changing of the oil flow rate from the chambers 15 in addition to the spring force on the vanes 13, 14, reacts to torque applied from the chain via the blade shoes 6 and 7 to dampen the motion of the chain 5.

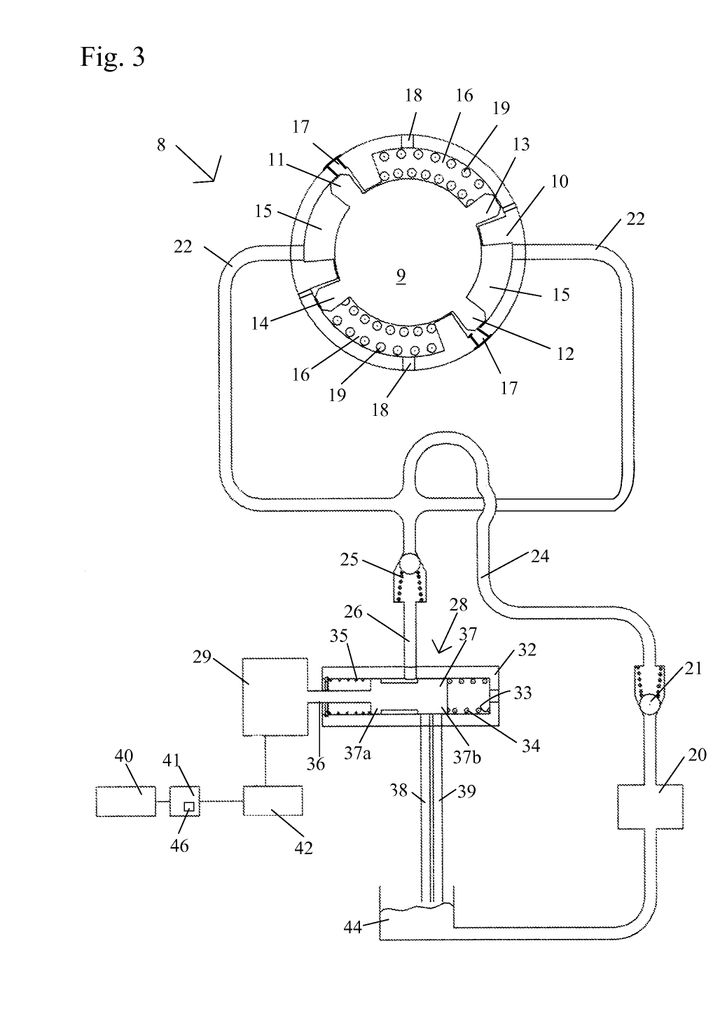

Referring to FIG. 3, when there is a decrease in force of the actuator 29 on the spool land 37a, the force of spring 34 on spool land 37b overcomes the force of the actuator 29 and force of spring 35 on spool 37 and urges the spool 37 to the far left. In the second position, spool land 37b blocks line 38, 39 into the valve and no fluid leaves through the lines 38, 39.

Since fluid flow from the chambers 15 is limited, as chain force on the blade shoes 6, 7 is at low chain tension, the tensioner 8 is allowed to rotate under the supply pressure and spring force. As the chain tension increases, outward flow from chambers 15 is restricted. As result of chain tension cycling between high and low tensions, the tensioner body is able to ratchet up in position (pump up).

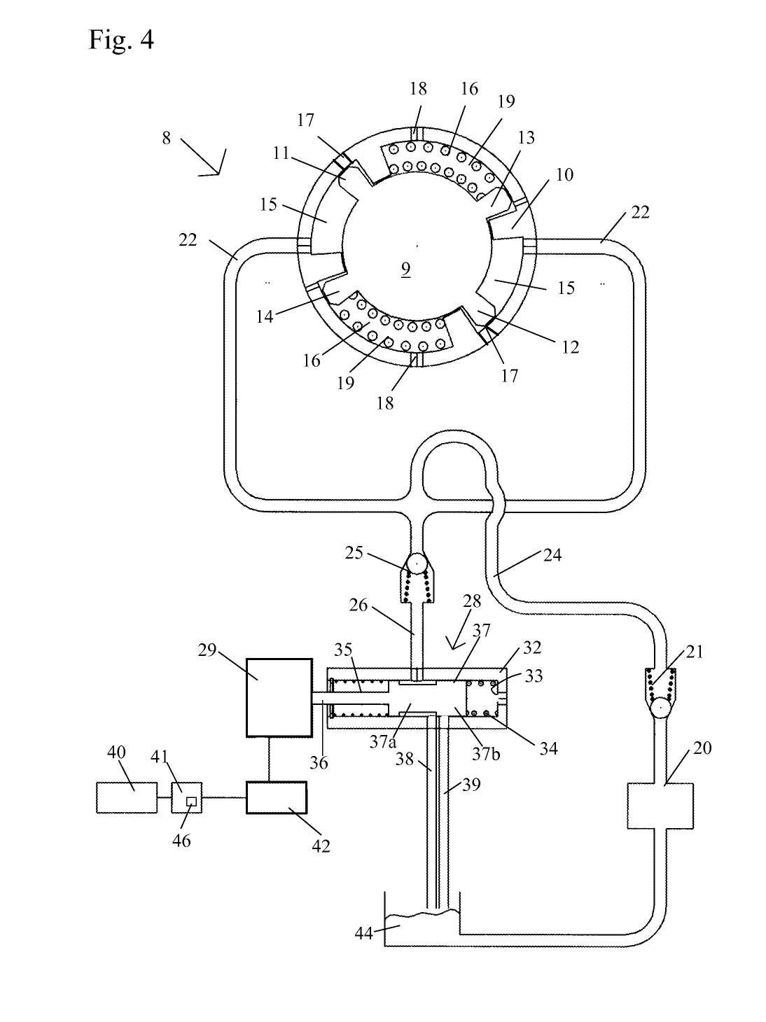

FIG. 4 shows the spool 37 in a third position in which the force of the spring 34 on spool land 37b is equal to the force of the actuator 29 on spool 37. In this position, spool land 37b preferably blocks at least one hydraulic line 39 and at least one other hydraulic line 38 is open between the chambers 15 and the oil reservoir 44. In this position, the chain is partially damped. It should be noted that the spool valve may stop at a multitude of positions when the forces on either end of the spool valve are equal or balanced.

In the above embodiment, the actuator 29 may alternatively be an on/off solenoid, push/pull solenoid, open frame or closed frame, pulse width modulated solenoid, variable force actuated solenoid, DC servo, servo, stepper motor or any other mechanical, electrical, pneumatic, hydraulic, vacuum actuator, or any combination thereof.

While four chambers are shown, any number of chambers may be used. While two lines are shown between the valve and the oil reservoir or sump, one line or additional lines may be present and within the scope of the present invention.

Alternatively, lines 38 and 39 may be in direct fluid communication with line 24 instead of in direct fluid communication with oil reservoir 44.

In another embodiment, a pressure relief valve may not be present in line 26.

In another embodiment, the valve 28 may be located within the tensioner body 9 or tensioner housing 10.

By using a valve 28 with multiple positions, variably controlled by an actuator 29, the damping of the tensioner 8 may be varied to be more soft (more leakage and more damping) or less soft (less leakage and less effective damping) or anywhere in between as necessary to meet the tensioning needs of the system and actively control or vary the damping of the tensioner 8.

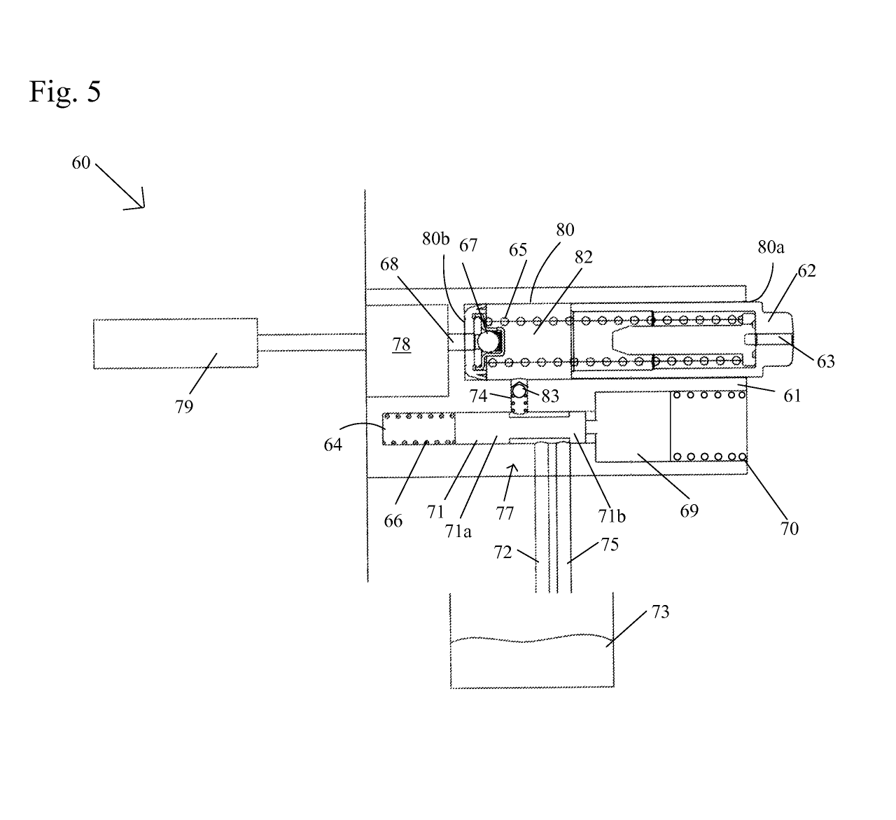

FIGS. 5 through 7 show a schematic of an actively controlled linear tensioner 60 with a valve 77 in the tensioner body 61. The tensioner body 61 includes a bore 80 with an open end 80a and a second end 80b. A hollow piston 62 is slidably received within the bore 80. In one embodiment, the hollow piston 62 has a vent hole 63 present up through the top of the piston 62. The piston 62 contacts an arm, blade shoe, or guide adjacent a belt or chain in a tensioner system for an engine including at least one driven sprocket, and at least one driving sprocket (not shown).

A pressure chamber 82 is formed between the piston 62 and the bore 80 of the tensioner body 61. Within the pressure chamber 82 is a piston biasing spring 65 and a check valve assembly 67 at the second end 80b of the bore 80. The second end 80b of the bore 80 is supplied with oil from an oil pump 79 and oil reservoir 78 through an inlet line 68 between the second end 80b of the bore 80 and the oil reservoir 78. The check valve assembly 67 prevents the back flow of fluid from the pressure chamber 82 back into the tensioner reservoir 78.

Within the tensioner body 61 is a valve 77 controlled by an actuator 69 in fluid communication with the pressure chamber 82 through line 74. A pressure relief valve 83 is preferably present in line 74 and prevents fluid from flowing directly from the oil pump 79 to the oil reservoir 73. A spool 71 is slidably received within a bore 64 of the tensioner body 61. The spool has at least two cylindrical lands 71a, 71b which fit snugly within the bore 64 of the tensioner housing 61 and are capable of selectively blocking the flow of engine oil to at least one hydraulic line, although at least two hydraulics lines 72, 75 are preferably present. The hydraulic lines 72, 75 are preferably flow restricted. While only two hydraulic lines are shown, one hydraulic line or multiple hydraulic lines may be used as well as multiple flow restrictors per line. In another embodiment, the valve 77 may be located remotely from the tensioner body 61 of the tensioner 60.

The position of spool 71 within tensioner body 61 is influenced by two distinct sets of opposing forces. Spring 66 acts on the end of land 71a and resiliently urges spool 71 to the right in the orientation illustrated in FIGS. 5-7. A second spring 70 acts on actuator 69, which acts on spool land 71b and resiliently urges spool 71 to the left in the orientation illustrated in FIGS. 5-7. The actuator 69 contacts spool land 71b. Land 71b may extend to block lines 72 and 75 to prevent back flow against the actuator 69. Additional flow paths may be placed in the housing 61 adjacent the actuator 69 or in the bore 64 between the spool 71 and the actuator 69. Alternatively, a spring attached to a separate mounting may act on spool land 71b in addition to the actuator 69.

Referring to FIG. 5, as the force on the spool 71 from the actuator 69 and spring 70 is decreased and is less than the force of the spring 66, the spool 71 is urged to the far right towards a first position, by the force of the spring 66 until the force of the actuator 69 on the spool land 71b is equal to or balanced with the force of the spring 66 on spool land 71a. When the spool 71 is in this first position, hydraulic lines 72, 75 are unblocked, allowing oil to flow from the pressure chamber 82 and out at least one of the lines 72, 75 to oil reservoir 73 or back to reservoir 78. Alternatively, the system could be spring biased towards blocking hydraulic lines 72, 75.

The amount of damping of the linear tensioner 60 is dependent on the number of lines 72, 75 that are open to oil reservoir 73 and the pressure chambers 82, and may become increasingly softer as more than one line 72, 75 between the valve 77 and the oil reservoir 73 is allowed to drain to oil reservoir 73. With the fluid exiting the pressure chamber 82 the damping of a chain by the linear tensioner 60 becomes softer and at its extreme limit there is either full restriction of flow of or virtually no amount of resistance to the flow of fluid out of the pressure chamber.

Inside the practical range of the tensioner, the more the tensioner leaks, the softer the tensioner is and more energy is lost to pumping and greater effective damping results. The less the tensioner leaks, the less soft the tensioner is and the less energy is lost to pumping and less effective damping results.

With the fluid exiting through lines 72, 75 to oil reservoir 73, the decrease in oil pressure in the pressure chamber 82 due to the changing of the oil flow rate from the pressure chamber 82 in addition to the spring force on the piston 62, reacts to load directly or indirectly applied from the chain via the piston 62 and arms and/or guides to dampen the motion of the chain 5.

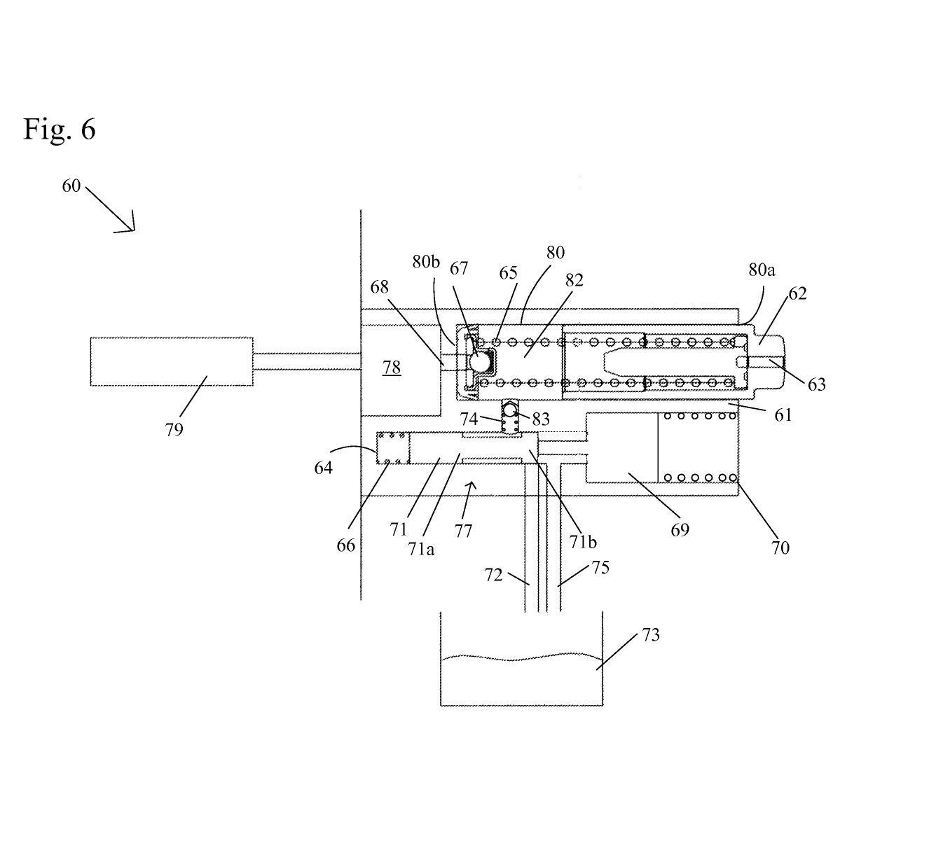

Referring to FIG. 6, as force on the spool 71 from the actuator 69 and spring 70 is increased and is greater than the force of the spring 66, the spool 71 is urged to the far left towards a second position, by the force of the actuator 69 and spring 70, until the force of the actuator 69 on the spool land 71b is equal to or balanced with the force of the spring 66 on spool land 71a. When the spool 71 is in this second position, the second land 71b blocks lines 72, 75 to oil reservoir 73. Additional flow paths may be placed in the housing 61 adjacent the actuator 69 or in the bore 64 between the spool 71 and the actuator 69. Alternatively, a spring attached to a separate mounting may act on spool land 71b in addition to the actuator 69.

With the fluid flow from the pressure chamber 82 being limited, the linear tensioner is at its least damping condition because only a very limited amount of oil is allowed to escape. The stiffness of the tensioner is based on the spring rate of the tensioner biasing spring 65 biasing the hollow piston 62 out of the tensioner body 61. The damping of the tensioner is based on the allowed fluid flow rate of the oil out of the pressure chamber 82 controlled by the valve 77 and the solenoid 69 based on engine parameters. The engine parameters may include, but is not limited to oil temperature, oil pressure, coolant temperature, phaser angle, throttle position, drive mode/drive gear, ambient temperature, number of active cylinders, number of hours on the system, engine revolutions per minute (RPM), and/or any other engine parameters.

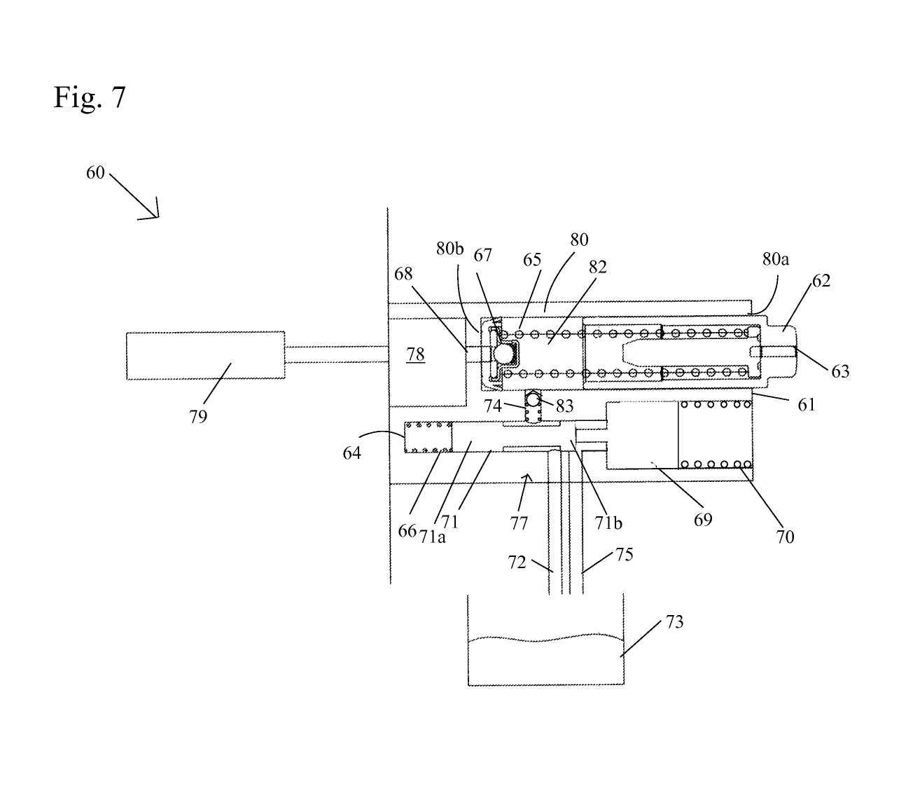

FIG. 7 shows the spool 71 in a third position in which the force of the spring 66 on spool land 71a is equal to the force of the spring 70 and actuator 69 on spool 71. In this position, spool land 71b preferably blocks at least one hydraulic line 75 and at least one other hydraulic line 72 is open between the pressure chambers 82 and the oil reservoir 73. In this position, the chain is partially dampened.

In the above embodiment, the actuator 69 may alternatively be alternatively be a pulse width modulated solenoid, a variable force actuated solenoid, an on/off solenoid, push/pull solenoid, open frame or closed frame, DC servo, stepper motor or any other mechanical, electrical, pneumatic, hydraulic or vacuum actuator, or any combination thereof.

While the valve is shown as being within the tensioner body 61, it is understood by one skilled in the art that the valve 77 alternatively may be located remote from the tensioner body 61.

In one embodiment, the force from an actuator 69 may be a variable force solenoid, which is exerted on an end of spool land 71b and is controlled by a pressure control signal from controller (not shown), preferably of the pulse-width modulated type (PWM), in response to a control signal from electronic engine control unit (ECU). The ECU receives an input signal with data from existing engine sensors. The input signal may be based on various engine control parameters and preferably include, but is not limited to oil temperature, oil pressure, coolant temperature, phaser angle, throttle position, drive mode/drive gear, ambient temperature, number of hours on the system, engine revolutions per minute (RPM), and/or other engine parameters. Within the ECU there preferably is a tensioner map that preferably includes a pre-calibrated matrix based on the function required for a specific engine model. Based on the tensioner map and an input signal, the ECU sends a signal to the controller to regulate the position of the valve 77.

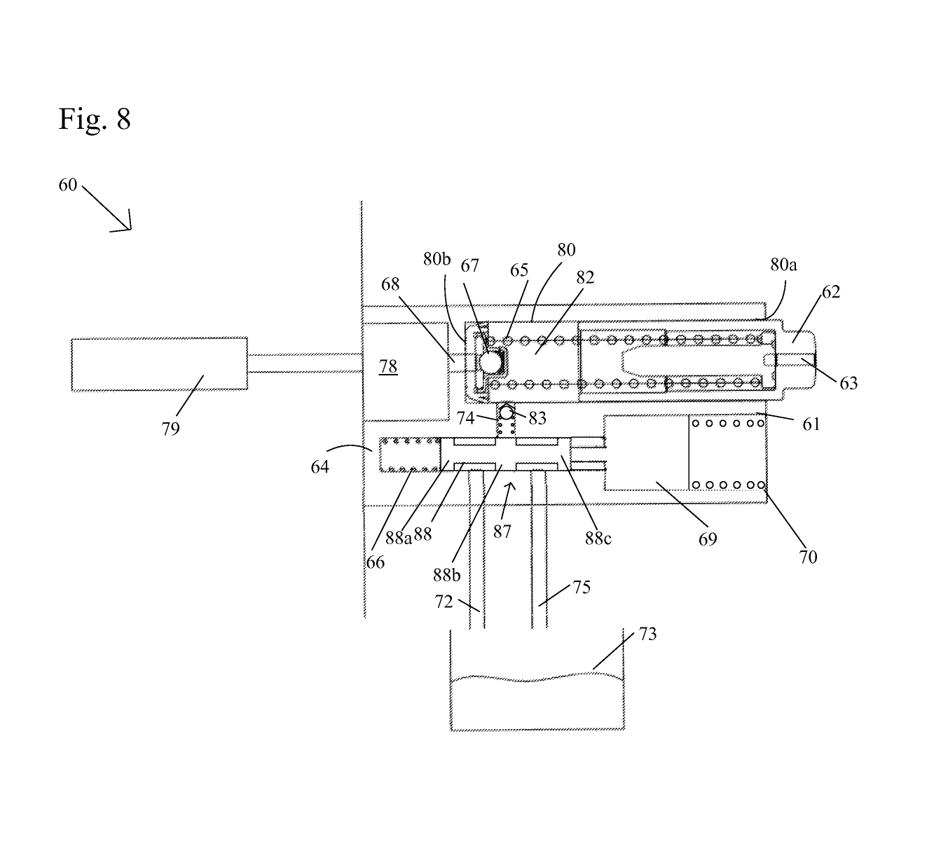

FIG. 8 shows a schematic of an actively controlled linear tensioner 60 similar to the tensioner shown in FIGS. 5-7, with a 3-way valve 87 in the tensioner body 61 instead of valve 77. The tensioner body 61 includes a bore 80 with an open end 80a and a second end 80b. A hollow piston 62 is slidably received within the bore 80. The piston 62 contacts an arm, blade shoe, or guide adjacent a belt or chain in a tensioner system for an engine including at least one driven sprocket, and at least one driving sprocket (not shown). In one embodiment, the hollow piston 62 has a vent hole 63 present up through the top of the piston 62.

A pressure chamber 82 is formed between the piston 62 and the bore 80 of the tensioner body 61. Within the pressure chamber 82 is a piston biasing spring 65 and a check valve assembly 67 at the second end 80b of the bore 80. The second end 80b of the bore 80 is supplied with oil from an oil pump 79 and oil reservoir 78 through an inlet line 68 between the second end 80b of the bore 80 and the oil reservoir 78. The check valve assembly 67 prevents the back flow of fluid from the pressure chamber 82 back into the tensioner reservoir 78.

The 3-way valve 87 has a spool 88 slidably received within a bore 64 of the tensioner body 61. The spool 88 has at least three cylindrical lands 88a, 88b, 88c which fit snugly within the bore 64 of the tensioner housing 61 and are capable of selectively blocking the flow of engine oil to at least one hydraulic line, although two hydraulic lines 72, 75 are preferably present and flow restricted. While only two hydraulic lines are shown, one hydraulic line or multiple hydraulic lines may be used as well as multiple flow restrictors per line. In an alternate embodiment, the valve 87 may be located remotely from the tensioner body 61 of the tensioner 60. In another alternate embodiment, hydraulic lines 72, 75 may be in fluid communication with oil reservoir 78. Alternatively, the system could be spring biased towards blocking hydraulic lines 72, 75.

The position of spool 88 within tensioner body 61 is influenced by two distinct sets of opposing forces. Spring 66 acts on the end of land 88a and resiliently urges spool 88 to the right in the orientation illustrated in FIG. 8. A second spring 70 acts on actuator 69, which acts on spool land 88c and resiliently urges spool 88 to the left in the orientation illustrated in FIG. 8. The actuator 69 contacts spool land 88c. Land 88c may extend to block lines 72 and 75 to prevent back flow against the actuator 69. Additional flow restrictors may be placed in the housing 61 adjacent the actuator 69 or in the bore 64 between the spool 88 and the actuator 69. Alternatively, a spring attached to a separate mounting may act on spool land 88c in addition to the actuator 69.

Depending on the position of the valve 87 and the pressure of the fluid in the pressure chamber 82 formed between the bore 80 of the tensioner body 61 and the piston 62, fluid may exit the pressure chamber 82 through hydraulic line 74 to the valve 87 through at least one hydraulic line 72, 75 leading to oil reservoir 73 or back to reservoir 78. The valve 87 is actuated by an actuator 69.

The actuator 69 moves the three way valve 87 in the tensioner body 61, either allowing fluid to be removed from the pressure chamber 82, actively adjusting the damping of the tensioner to be softer or allowing the pressure of the fluid in the pressure chamber 82 to build in varying degrees.

When the force of the actuator 69 on the end of the spool of the valve 87 is greater than the force on the opposite end of the spool and the spool is moved until the force of the actuator 69 on the spool land 88c is equal to or balanced with the force of the spring 66 on spool land 88a, and at least one line 72, 75 between the valve 87 and oil reservoir 73 is open, fluid flows out of the pressure chamber 82 causing damping of the linear tensioner to become softer. The damping of the linear tensioner may become increasingly softer as flow is redirected from one line 72 to a second line 75 (or vise versa). Additionally, when the force of the actuator 69 on spool land 88c of the valve 87 is less than the force of spring 66 on spool land 88a, or is greater than the force of spring 66 on spool land 88a, at least one of the lines 72, 75 is open to the reservoir 73 and/or alternatively to oil reservoir 78.

When the force of the actuator 69 on spool land 88c of the valve 87 is equal to the force of spring 66 on spool 88a, spool land 88b preferably blocks line 74 and prevents fluid from exiting through lines 72, 75 to reservoir 73 or back to reservoir 78. With lines 72, 75 blocked by spool land 88b, the damping of the linear tensioner is at its lowest since only a very limited amount of oil is allowed to escape. The stiffness of the tensioner is based on the spring rate of the tensioner biasing spring 65 biasing the hollow piston 62 out of the tensioner body 61. The damping of the tensioner is based on the allowed fluid flow rate of the oil out of the pressure chamber 82 controlled by the valve 87 and the actuator 69 based on engine parameters. The engine parameters may include, but is not limited to oil temperature, oil pressure, coolant temperature, phaser angle, throttle position, drive mode/drive gear, ambient temperature, number of active cylinders, number of hours on the system, engine revolutions per minute (RPM) and/or any other combination thereof.

Inside the practical range of the tensioner, the more the tensioner leaks, the softer the tensioner is and more energy is lost to pumping and greater effective damping results. The less the tensioner leaks, the less soft the tensioner is and the less energy is lost to pumping and less effective damping results.

In the above embodiment, the actuator 69 may alternatively be a pulse width modulated solenoid, a variable force actuated solenoid, an on/off solenoid, push/pull solenoid, open frame or closed frame, DC servo, stepper motor or any other mechanical, electrical, pneumatic, hydraulic or vacuum actuator, or any combination thereof.

In one embodiment, the force from an actuator 69 may be a variable force solenoid, which is exerted on an end of spool land 88c and is controlled by a pressure control signal from controller (not shown), preferably of the pulse-width modulated type (PWM), in response to a control signal from electronic engine control unit (ECU). The ECU receives an input signal with data from existing engine sensors. The input signal may be based on various engine control parameters and preferably include, but is not limited to oil temperature, oil pressure, coolant temperature, phaser angle, throttle position, drive mode/drive gear, ambient temperature, number of hours on the system, engine revolutions per minute (RPM), and/or other engine parameters. Within the ECU there preferably is a tensioner map that preferably includes a pre-calibrated matrix based on the function required for a specific engine model. Based on the tensioner map and an input signal, the ECU sends a signal to the controller to regulate the position of the valve 87.

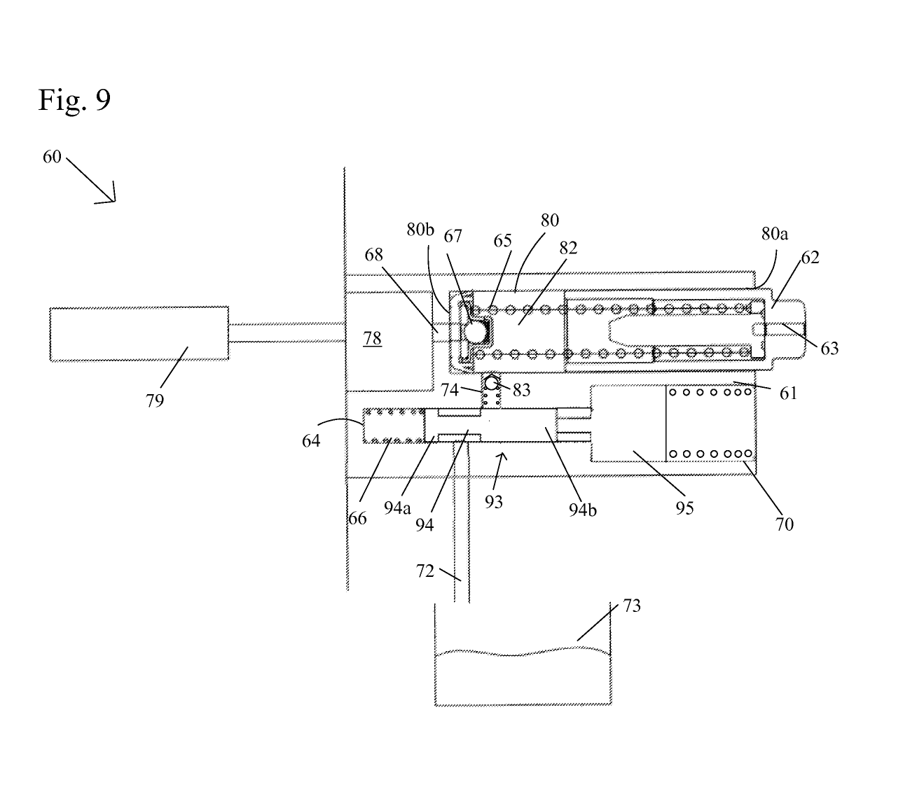

FIG. 9 shows a schematic of an actively controlled linear tensioner 60 similar to the tensioner shown in FIGS. 5-7, with a servo actuated valve 93 in the tensioner body 61 instead of valve 77. The tensioner body 61 includes a bore 80 with an open end 80a and a second end 80b. A hollow piston 62 is slidably received within the bore 80. The piston 62 contacts an arm, blade shoe, or guide adjacent a belt or chain in a tensioner system for an engine including at least one driven sprocket, and at least one driving sprocket (not shown). In one embodiment, the hollow piston 62 has a vent hole 63 present up through the top of the piston 62.

A pressure chamber 82 is formed between the piston 62 and the bore 80 of the tensioner body 61. Within the pressure chamber 82 is a piston biasing spring 65 and a check valve assembly 67 at the second end 80b of the bore 80. The second end 80b of the bore 80 is supplied with oil from an oil pump 79 and oil reservoir 78 through an inlet line 68 between the second end 80b of the bore 80 and the oil reservoir 78. The check valve assembly 67 prevents the back flow of fluid from the pressure chamber 82 back into the tensioner reservoir 78.

The servo valve 93 has a spool 94 slidably received within a bore 64 of the tensioner body 61. The spool 94 has at least two cylindrical lands 94a, 94b, which fit snugly within the bore 64 of the tensioner housing 61 and are capable of selectively blocking the flow of engine oil to at least one hydraulic line 72. The hydraulic line 72 is not flow restricted, since the servo actuated valve 93 will control and vary the flow restriction as necessary. The servo 95 may be electrical, partially electronic, hydraulic, pneumatic, or magnetic. While only one hydraulic line is shown, additional hydraulic lines may be used. In another embodiment, the valve 93 may be located remotely from the tensioner body 61 of the tensioner 60. Alternatively, the system could be spring biased towards blocking hydraulic line 72.

The position of spool 94 within tensioner body 61 is influenced by two distinct sets of opposing forces. Spring 66 acts on the end of land 94a and resiliently urges spool 94 to the right in the orientation illustrated in FIG. 9. A second spring 70 acts on actuator 95, which acts on land 94b and resiliently urges spool 94 to the left in the orientation illustrated in FIG. 9. The servo actuator 95 contacts spool land 94b. Land 94b may extend to block line 72 to prevent back flow against the actuator 95. Additional flow paths may be placed in the housing 61 adjacent the actuator 95 or in the bore 64 between the spool 93 and the actuator 95. Alternatively, a spring attached to separate mounting may act on spool land 94b in addition to the actuator 95.

Depending on the position of the valve 93 and the pressure of the fluid in the pressure chamber 82 formed between the bore 80 of the tensioner body 61 and the piston 62, fluid may exit the pressure chamber 82 through hydraulic line 74 to the valve 93 through hydraulic line 72 leading to oil reservoir 73. In an alternate embodiment, hydraulic line 72 would be in fluid communication with oil reservoir 78.

The servo 95 moves the valve 93 in the tensioner body 61, either allowing fluid to be removed from the pressure chamber 82, actively adjusting the damping of the tensioner to be softer or allowing the pressure of the fluid in the pressure chamber 82 to build in varying degrees. When the force of the servo 95 and spring 70 on spool land 94b is greater than the force of spring 66 on spool land 94a, the spool is moved until the force of the spring 66 on spool land 94a is equal to the force of the actuator 95 on spool land 94b, and line 72 between the valve 93 and oil reservoir 73 is open and fluid flows out of the pressure chamber 82 causing damping of the linear tensioner to become softer. The damping of the linear tensioner may become increasingly softer as controlled by the servo. With the fluid exiting the pressure chamber 82, the damping of a chain by the linear tensioner 60 becomes softer and at its extreme limit there is either full restriction of flow of or virtually no amount of resistance to the flow of fluid out of the pressure chamber. When the force of the servo 95 and spring 70 on spool land 94b is less than the force of spring 66 on spool land 94a, the spool is moved until the force of the spring 66 on spool land 94a is equal to the force of the actuator 95 on spool land 94b, and line 72 between the valve 93 and the oil reservoir 73 is closed.

When the force of the servo 95 and spring 70 on spool land 94b of the valve 93 is equal to the force of spring 66 on spool land 94a, and the spool is moved to the left, spool land 94b preferably blocks line 74 and prevents fluid from exiting through line 72 to reservoir 73. With line 74 blocked by spool land 94b, the stiffness of the linear tensioner is at its greatest since only a very limited amount of oil is allowed to escape. The stiffness and damping of the tensioner is based on the spring rate of the tensioner biasing spring 65 biasing the hollow piston 62 out of the tensioner body 61 and the allowed fluid flow rate of the oil out of the pressure chamber 82 controlled by the valve 93 and the actuator 95 based on engine parameters. The engine parameters may include, but is not limited to oil temperature, oil pressure, coolant temperature, phaser angle, throttle position, drive mode/drive gear, ambient temperature, number of active cylinders, number of hours on the system, engine revolutions per minute (RPM) and/or any combination thereof.

Inside the practical range of the tensioner, the more the tensioner leaks, the softer the tensioner is and more energy is lost to pumping and greater effective damping results. The less the tensioner leaks, the less soft the tensioner is and the less energy is lost to pumping and less effective damping results.

In the above embodiment, the actuator 95 may alternatively be a pulse width modulated solenoid, a variable force actuated solenoid, an on/off solenoid, push/pull solenoid, open frame or closed frame, DC servo, stepper motor or any other mechanical, electrical, pneumatic, hydraulic or vacuum actuator, or any combination thereof.

While the valve is shown as being within the tensioner body, alternatively, the valve 93 may be located remote from the tensioner body 61.

In one embodiment, the force from an actuator 95 may be a variable force solenoid, which is exerted on an end of spool land 88c and is controlled by a pressure control signal from controller (not shown), preferably of the pulse-width modulated type

(PWM), in response to a control signal from electronic engine control unit (ECU). The ECU receives an input signal with data from existing engine sensors. The input signal may be based on various engine control parameters and preferably include, but is not limited to oil temperature, oil pressure, coolant temperature, phaser angle, throttle position, drive mode/drive gear, ambient temperature, number of hours on the system, engine revolutions per minute (RPM), and/or other engine parameters. Within the ECU there preferably is a tensioner map that preferably includes a pre-calibrated matrix based on the function required for a specific engine model. Based on the tensioner map and an input signal, the ECU sends a signal to the controller to regulate the position of the valve 87.

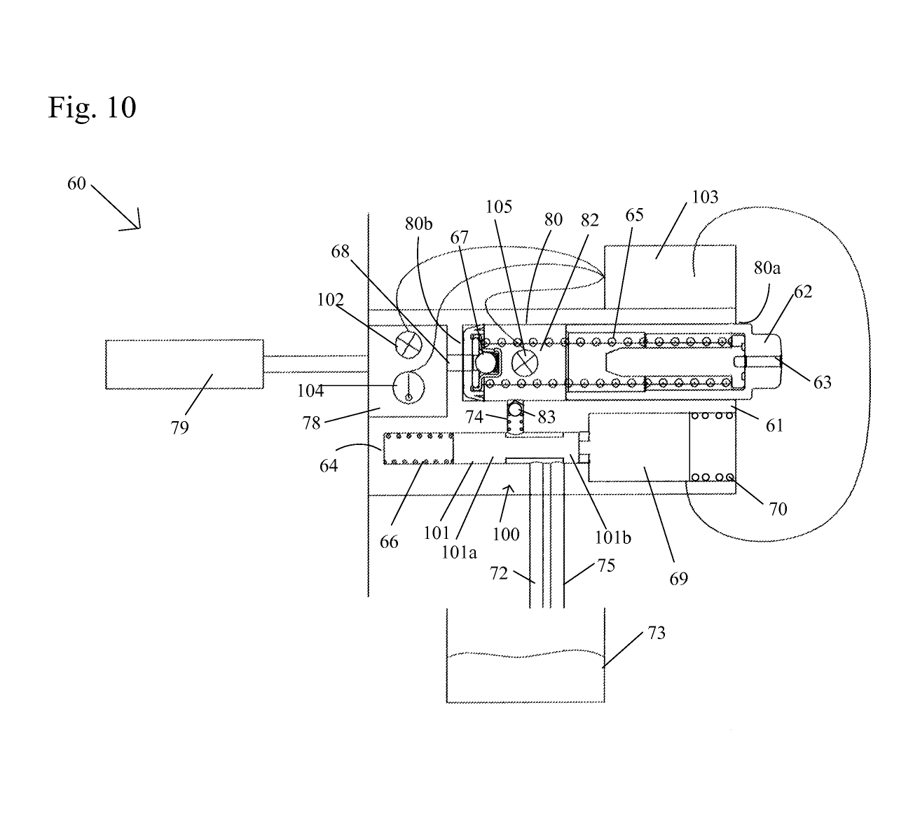

FIGS. 10 through 12 show a schematic of an actively controlled linear tensioner 60 with a valve 100 in the tensioner body 61. The tensioner body 61 includes a bore 80 with an open end 80a and a second end 80b. A hollow piston 62 is slidably received within the bore 80. The piston 62 contacts an arm, blade shoe, or guide adjacent a belt or chain in a tensioner system for an engine including at least one driven sprocket, and at least one driving sprocket (not shown). In one embodiment, the hollow piston 62 has a vent hole 63 present up through the top of the piston 62.

A pressure chamber 82 is formed between the piston 62 and the bore 80 of the tensioner body 61. Within the pressure chamber 82 is a piston biasing spring 65 and a check valve assembly 67 at the second end 80b of the bore 80. The second end 80b of the bore 80 is supplied with oil from an oil pump 79 and oil reservoir 78 through an inlet line 68 between the second end 80b of the bore 80 and the oil reservoir 78. The check valve assembly 67 prevents or limits the back flow of fluid from the pressure chamber 82 back into the tensioner reservoir 78.

Within the tensioner body 61 is a valve 100 controlled by an actuator 69 in fluid communication with the pressure chamber 82 through line 74 and controlled by a controller 103 electronically coupled to the actuator 69. A pressure relief valve 83 is present in line 74 and oil from the pump 79 directly feeding through the pressure relief valve as pop off pressure is lower than oil supply pressure. A spool 101 is slidably received within a bore 64 of the tensioner body 61. The spool 101 has at least two cylindrical lands 101a, 101b which fit snugly within the bore 64 of the tensioner housing 61 and are capable of selectively blocking the flow of engine oil to at least one hydraulic line flow restricted, although two hydraulic lines 72, 75 are preferably present and flow restricted. While only two hydraulic lines are shown, one hydraulic line or multiple hydraulic lines may be used as well as multiple flow restrictors per line. In other embodiments, the valve 100 may be located remotely from the tensioner body 61 of the tensioner 60. Alternatively, the system could be spring biased towards blocking hydraulic lines 72, 75. Alternatively, if the-actuator 69 was a servo as shown in FIG. 9, only one hydraulic line 72 would be present to the reservoir 73 and flow restrictors on line 72 would not be necessary. In an alternate embodiment, the valve 100 may be located remotely from the tensioner body 61 of the tensioner 60. In another alternate embodiment, hydraulic lines 72, 75 may be in fluid communication with oil reservoir 78. Alternatively, the system could be spring biased towards blocking hydraulic lines 72, 75.

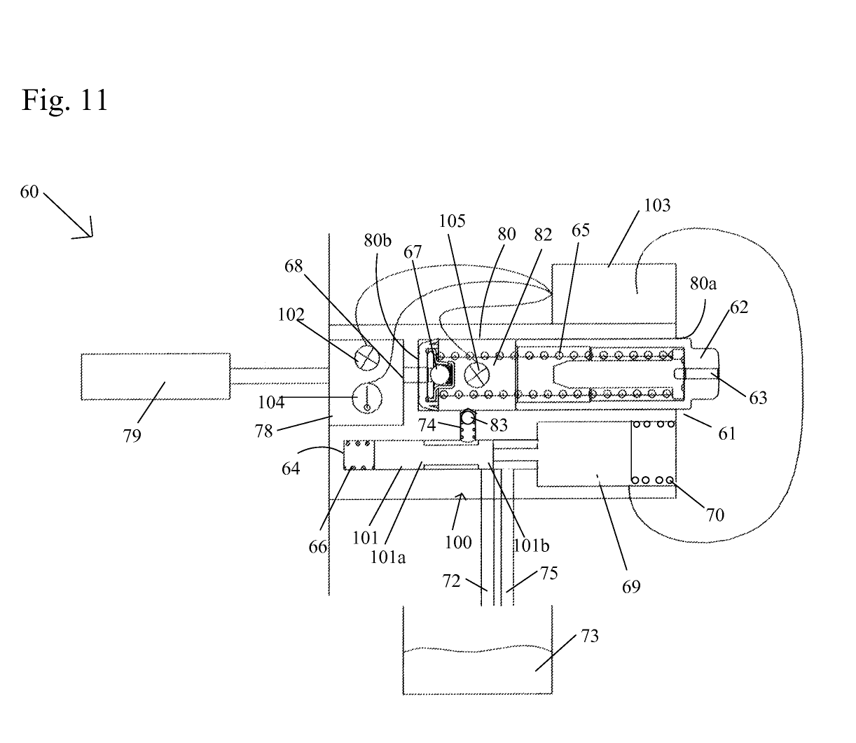

The position of spool 101 within tensioner body 61 is influenced by two distinct sets of opposing forces. Spring 66 acts on the end of land 101a and resiliently urges spool 101 to the right in the orientation illustrated in FIG. 10. A second spring 70 acts on actuator 69, which acts on spool land 101b and resiliently urges spool 101 to the left in the orientation illustrated in FIG. 11. The actuator 69 contacts spool land 101b. Alternatively, a spring attached to separate mounting may act on spool land 101b in addition to the actuator 69. It should be noted that land 101b is preferably sufficiently long enough to prevent backflow into the cavity between actuator 69 and land 101b or alternatively, the portion of the actuator 69 in contact with land 101b is approximately equal to the diameter of the spool land 101b. Alternatively, a spring attached to a separate mounting may act on spool land 101b in addition to the actuator 69.

A pressure transducer 102 for measuring the pressure of the oil reservoir 78 is present in proximity of the oil reservoir 78 and is electronically coupled to the controller 103. A thermocouple 104 for monitoring and measuring the temperature of the oil reservoir 78 is present in proximity of the oil reservoir 78 and is electronically coupled to a controller 103. The thermocouple 104 and the pressure transducer 102 may be present in the oil reservoir 78 or any other place within the tensioner body that allows proper measurements of the pressure and the temperature of the oil reservoir 78.

The pressure and the temperature of the oil reservoir 78 is sent to and monitored by the controller 103. The controller 103 is electronically coupled to the actuator 69. The controller 103 sends a signal to the actuator 69 based on the thermocouple 104 and pressure transducer 102 in proximity to the oil reservoir 78. The signal may be pulse width modulated. The actuator 69 moves the valve 100 in the tensioner body 61, either allowing fluid to be removed from the pressure chamber 82, actively adjusting the damping of the linear tensioner 60 to be softer or allowing the pressure of the fluid in the pressure chamber 82 to build and the softness to decrease. The controller 103 may or may not be powered by the ECU of the engine and is preferably powered remotely or by battery.

In one embodiment, the force from an actuator 69 may be a variable force solenoid, which is exerted on an end of spool land 101b and is controlled by a pressure control signal and/or temperature control signal from the controller (not shown), preferably of the pulse-width modulated type (PWM), in response to a control signal from electronic engine control unit (ECU). The ECU receives an input signal with data from existing engine sensors such as from the pressure transducer and/or thermocouple. The input signal may be based on various engine control parameters and preferably include, but is not limited to oil temperature, oil pressure, coolant temperature, phaser angle, throttle position, drive mode/drive gear, ambient temperature, number of hours on the system, engine revolutions per minute (RPM), and/or other engine parameters. Within the ECU there preferably is a tensioner map that preferably includes a pre-calibrated matrix based on the function required for a specific engine model. Based on the tensioner map and an input signal, the ECU sends a signal to the controller to regulate the position of the valve 100.

An additional pressure transducer 105 may be present in proximity to the pressure chamber 82 formed between the piston 62 and the bore 80 of the tensioner body 61 for measuring the pressure in the pressure chamber 82. The additional pressure transducer 105 is electronically coupled to the controller 103 and provides feedback to the controller 103 regarding the pressure in the pressure chamber 82 and the amount of damping of the chain to allow the controller 103 to alter the valve position through the actuator 69 and thus actively and variably control the damping.

Referring to FIG. 10, as the force on the spool 101 from the actuator 69 and spring 70 is decreased and is less than the force of the spring 66, the spool is urged to the far right towards a first position, by the force of the spring 66, until the force of the spring 66 on spool land 101a is equal to the force of the actuator 69 and spring 70 on spool land 101b. When the spool 101 is in this first position, hydraulic lines 72, 75 are unblocked, allowing oil to flow from the pressure chamber 82 and out at least one of the lines 72, 75 to oil reservoir 73 or back to reservoir 78. In another embodiment, the valve could be spring biased towards blocking hydraulic lines 72, 75.

The amount of damping of the linear tensioner 60 is dependent on the number of lines 72, 75 that are open to oil reservoir 73, the temperature of the oil in the oil reservoir, the pressure in the oil reservoir, and the pressure in the pressure of the oil in the pressure chambers 82, and may become increasingly softer as more than one line 72, 75 between the valve 100 and the oil reservoir 73 is allowed to drain to oil reservoir 73. With the fluid exiting the pressure chamber 82, the damping of a chain by the linear tensioner 60 becomes softer and at its extreme limit there is either full restriction of flow of or virtually no amount of resistance to the flow of fluid out of the pressure chamber. With the fluid exiting through lines 72, 75 to oil reservoir 73, or alternatively to oil reservoir 78, the changing of the oil flow rate from the pressure chamber 82 due to the decrease in oil pressure in the pressure chamber in addition to the spring force on the piston 62, reacts to load applied from the chain via the piston 62 to dampen the motion of the chain 5.

Referring to FIG. 11, as force on the spool 101 from the actuator 69 and spring 70 is increased and is greater than the force of the spring 66, the spool 101 is urged to the far left towards a second position, by the force of the actuator 69 and spring 70 until the force of the spring 66 on spool land 101a is equal to the force of the actuator 69 and spring 70 on spool land 101b. When the spool 101 is in this second position, the second land 101b blocks lines 72, 75 to oil reservoir 73. Additional flow paths may be placed in the housing 61 adjacent the actuator 69 or in the bore 64 between the spool 101 and the actuator 69. Alternatively, a spring attached to a separate mounting may act on spool land 101b in addition to the actuator 69.

With the fluid flow from the pressure chamber 82 being limited, the tensioner is less soft, since only a very limited amount of oil is allowed to escape. The stiffness of the tensioner is based on the spring rate of the tensioner biasing spring 65 biasing the hollow piston 62 out of the tensioner body 61. The damping of the tensioner is based on the allowed fluid flow rate of the oil out of the pressure chamber 82 controlled by the valve 100 and the actuator 69 based on engine parameters, pressure of the reservoir 78, temperature of the reservoir 78, and pressure of the pressure chamber 82. The engine parameters may include, but is not limited to oil temperature, oil pressure, coolant temperature, phaser angle, throttle position, drive mode/drive gear, ambient temperature, number of active cylinders, number of hours on the system, engine revolutions per minute (RPM), and/or any other engine parameters.

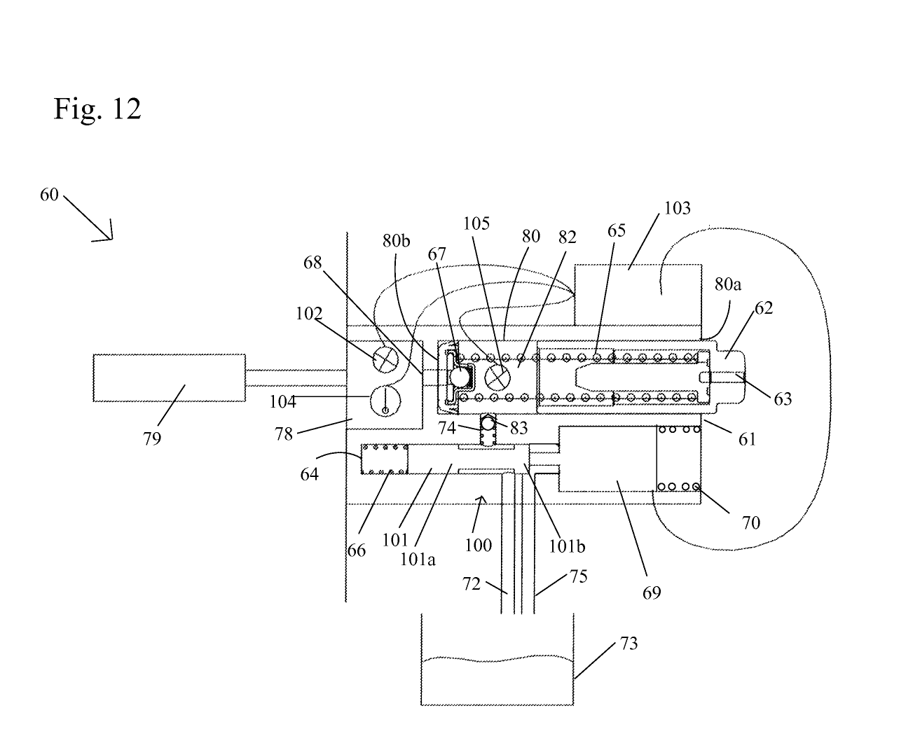

FIG. 12 shows the spool 101 in a third position in which the force of the spring 66 on spool land 101a is equal to the force of the spring 70 and actuator 69 on spool 101. In this position, spool land 101b preferably blocks at least one hydraulic line 75 and at least one other hydraulic line 72 is open between the pressure chambers 82 and the oil reservoir 73. In this position, the chain is partially damped.

Inside the practical range of the tensioner, the more the tensioner leaks, the softer the tensioner is and more energy is lost to pumping and greater effective damping results. The less the tensioner leaks, the less soft the tensioner is and the less energy is lost to pumping and less effective damping results.

In the above embodiment, the actuator 69 may alternatively be alternatively be a pulse width modulated solenoid, a variable force actuated solenoid, an on/off solenoid, push/pull solenoid, open frame or closed frame, DC servo, stepper motor or any other mechanical, electrical, pneumatic, hydraulic or vacuum actuator, or any combination thereof.

While the valve is shown as being within the tensioner body 61, it is understood by one skilled in the art that the valve 101 alternatively may be located remote from the tensioner body 61.

At least one pressure transducer and at least one thermocouple may also be present in the rotary tensioner of FIGS. 1-5. At least one pressure transducer may be present in oil reservoir 44 and/or in pressure chamber 15 and at least one thermocouple may be present in the oil reservoir 44. As in the above embodiment, the pressure transducer would measure pressure of the oil reservoir 44 and would be electronically coupled to the controller 42 or ECU 41 or a separate controller similar to 103. The thermocouple would monitor and measure the temperature of the oil reservoir and would also be electronically coupled to the controller 42 or ECU 41 or a separate controller similar to 103. The thermocouple and pressure transducer may be present in other portions of the rotary tensioner that allow for proper measurements of the pressure and temperature of the oil reservoir 44. Based on the pressure and temperature of the oil reservoir 44, the ECU 41 would send a control signal to the controller and to the actuator to regulate the position of the valve 28 of a first embodiment or controlled by the separate controller similar to 103.

The tensioners of the above embodiments may or may not have racks.

Since the valves in all of the above embodiments may be biased to multiple positions, (e.g. not binary) by variable actuators, the tensioner may provide active variable damping to a chain.

In all of the above embodiments, the spool of the spool valve may also be positioned such that a small amount of fluid is always present and flowing through one of lines between the valve and oil reservoir.

In all of the above embodiments, when the force on opposing ends of the spool valve are balanced, the valve does not move. The spool valve is a multi-position valve with numerous positions and the positions shown in the figures and described in the specification are just examples.

In all of the above embodiments the pressure relief valves may also be disk type check valves or any other type of check valve.

In all of the above embodiments, the valve may be controlled by a classical control method included, but not limited to bang-bang, proportional (P), proportional-integral (PI), proportional-integral-derivative (PID), integral (I), derivative (D), lead-lag, and root locus. The valve may also be controlled by a modern control method, including but not limited to adaptive, model reference, self tuning, regulators, sliding mode, fuzzy logic, neural network, and state space controller or other control types.

In all of the above embodiments the actuator of the system may be closed loop control and may be applied to the system by providing feedback from, but not limited to pressure off of line 24 or valve/spool position, flow, or direct chain tension feedback to the ECU or actuator which then alters the position of the spool valve. Alternatively, the actuator of the system may also be open loop control.

In all of the above embodiments, a current driver system may be alternately used in place of PWM.

In all of the above embodiments, a 4-way control valve may alternately used instead of a valve and a solenoid.

In all of the above embodiments, the tensioner may also tension a belt instead of chain and may use pulleys.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A tensioner system for an engine including at least one driven sprocket, at least one driving sprocket, a chain or a belt, and a tensioner for tensioning the chain or belt, the tensioner comprising:
a tensioner body having a bore;
a piston received by the bore of the tensioner body, forming a pressure chamber with the tensioner body;
a spring biasing the piston in the tensioner body;
a valve in fluid communication with the pressure chamber through a hydraulic line; and
at least one line in fluid communication with the valve and an oil reservoir;
wherein when the valve is moved to a first position, fluid exits the pressure chamber through the valve and into the at least one line in fluid communication with the oil reservoir, fluid losses from the pressure chamber variably softening and damping the tension applied to the chain or belt by the tensioner.

2. The system of claim 1, wherein the at least one line in fluid communication with the oil reservoir is flow restricted.

3. The system of claim 1, wherein when the valve is moved to a second position, fluid is blocked from exiting the pressure chamber to the at least one line in fluid communication with the oil reservoir and fluid is restricted from flowing to the oil reservoir.

4. The system of claim 1, further comprising an actuator for moving the valve, wherein the actuator is controlled by closed loop control.

5. The system of claim 4, wherein the actuator is a solenoid.

6. The system of claim 1, further comprising a fluid supply for supplying fluid to a second reservoir in fluid communication with the pressure chamber; a first pressure transducer for measuring a pressure of the second reservoir electrically coupled to a controller; and a thermocouple for measuring a temperature of the second reservoir, electrically coupled to the controller.

7. The system of claim 6, further comprising a second transducer for measuring pressure of the pressure chamber, electrically coupled to the controller.

8. The system of claim 1, wherein when the valve is moved to a third position, fluid exiting the pressure chamber through the valve to the oil reservoir is partially blocked by the valve.

9. The system of claim 1, further comprising a line in fluid communication with the valve and pressure chamber including a pressure relief valve.

10. The system of claim 1, wherein the valve is in the tensioner body.

11. A tensioner system for an engine including at least one driven sprocket, at least one driving sprocket, a chain or belt, and a tensioner for tensioning the chain or belt, the tensioner comprising:
a tensioner housing;
a rotary body secured within the tensioner housing rotatable around a central point having a series of vanes received within at least one chamber formed between the rotary body and the housing, wherein the chamber is formed between the vane and the housing and is in fluid communication with a fluid supply;
a valve in fluid communication with the chamber; and
at least one line in fluid communication with the valve and an oil reservoir;
wherein when the valve is moved to the a first position, fluid exits the at least one chamber through the valve and into the at least one line in fluid communication with the oil reservoir, fluid losses from the at least one chamber variably softening and damping the tension applied to the chain or belt by the tensioner.

12. The system of claim 11, wherein when the valve is moved to a second position, fluid is blocked from exiting the at least one chamber and fluid is restricted from flowing to the oil reservoir.

13. The system of claim 11, wherein the at least one chamber includes flow restrictors to atmosphere.

14. The system of claim 11, wherein when the valve is moved to a third position, fluid exiting the at least one chamber through the valve to the oil reservoir is partially blocked by the valve.

15. The system of claim 11, further comprising a second chamber including a biasing spring for biasing the vanes in a first direction.
